(19) United States
(12) Patent Application Publication
(10) Pub. No.: US 2012/0125663 A1
(43) Pub. Date: May 24, 2012

(54) WIRE HARNESS CLAMP

(75) Inventor: Miyoshi MABUCHI, Makinohara-shi (JP)

(73) Assignee: YAZAKI CORPORATION, Tokyo (JP)

(21) Appl. No.: 13/303,635

(22) Filed: Nov. 23, 2011

(30) Foreign Application Priority Data
Nov. 24, 2010 (JP) 2010-261258

(51) Int. Cl. F16L 3/12

(52) U.S. Cl. 174/135

(57) ABSTRACT

A wire harness clamp is provided. A loading plate has a first surface configured to load a wire harness thereon and a second surface opposite to the first surface. A harness fastening member is configured to fasten the wire harness to the first surface of the loading plate. A connection portion is formed on the second surface of the loading plate and configured to be fitted in and fixed to a clamp attachment hole which is foamed in a structure for arranging the wire harness thereon. The first surface of the loading plate is provided with a ridge. The ridge is configured to restrict a movement of the wire harness when the harness fastening member fastens the wire harness to the first surface of the loading plate so as to push the wire harness against the first surface of the loading plate and the ridge.

The disclosure of Japanese Patent Application No. 2010-261258 filed on Nov. 24, 2010, including specification, drawings and claims is incorporated herein by reference in its entirety.

### BACKGROUND

The invention relates to a wire harness clamp for fixing the wire harness to a wire harness arrangement path on a structure.

FIG. 8 illustrates a wire harness clamp according to the related art. Patent Document 1 discloses a wire harness clamp 101 including a loading plate 111, a harness fastening means 131, and a panel connection portion 151.

The loading plate 111 has a substantially flat plate shape and has an upper surface 111a and a lower surface 111b opposite to the upper surface 111a. The upper surface 111a is configured to load a wire harness 121 thereon. The loading plate 111 is foamed to be thin and long in the longitudinal direction of the wire harness 121.

The harness fastening means 131 fastens the wire harness 121 to the loading plate 111. For example, an adhesive tape may be used as the harness fastening means 131. The harness fastening means 131 is wound around the loading plate 111 and the wire harness 121 at both sides of the loading plate 111 interposing the panel connection portion 151 therebetween, thereby fixing the wire harness 121 to the loading plate 111.

The panel connection portion 151 is formed on the lower surface 111b so as to protrude from a central portion of the lower surface 111b of the loading plate 111 in the longitudinal direction of the loading plate 111. The panel connection portion 151 is configured to be fitted in and fixed to a clamp attachment hole 142 formed in a structure 141 for arranging the wire harness 121 thereon.

The panel connection portion 151 includes a central shaft 152 configured to pass through the center of the clamp attachment hole 142, spring pieces 153 extending obliquely from a leading end of the central shaft 152 toward a base end of the central shaft 152, and engagement grooves 154 formed on the outer surfaces of the spring pieces 153.

When inserting the panel connection portion 151 into the clamp attachment hole 142, the spring pieces 153 are bent toward the central shaft 152 and engage with the clamp attachment hole 142. As illustrated, when the engagement grooves 154 are moved to a position of a peripheral portion of the clamp attachment hole 142, the peripheral portion of the clamp attachment hole 142 is engaged with the engagement grooves 154 so that the panel connection portion 151 is fixed to the structure 141.

Patent Document 1: JP-A-2003-023722

In the wire harness clamp 101 of Patent Document 1, the wire harness 121 may move in an axial direction thereof (a direction of arrow X1 of FIG. 8) due to tension exerted on the wire harness 121. In addition, when torsion is exerted on the wire harness 121, the wire harness 121 may rotate around an axis thereof as shown by arrow R1.

The harness fastening means 131 is configured by tape winding. If a tape winding range is not large enough, it is impossible to obtain a sufficient fixing strength. In order to ensure the tape winding range, the loading plate 111 is required to have a long length, thereby causing a problem such as the large size and heavy weight of the wire harness clamp 101.

Also, since it is difficult to automate the tape winding operation, there is a problem in which it is difficult to improve the workability by automation.

### SUMMARY

It is therefore an object of the invention to provide a wire harness clamp capable of securely fixing a wire harness while restricting the movement of the wire harness in an axial direction thereof and/or the rotation of the wire harness around an axis thereof, achieving the small size and light weight, and improving the workability of the attachment of the wire harness by automation (mechanization) in an attachment operation of the wire harness.

The object of the present invention can be achieved by the following configurations of (1) to (5).

(1) A wire harness clamp, comprising: a loading plate having a first surface configured to load a wire harness thereon and a second surface opposite to the first surface; a harness fastening member configured to fasten the wire harness to the first surface of the loading plate; and a connection portion formed on the second surface of the loading plate and configured to be fitted in and fixed to a clamp attachment hole which is formed in a structure for arranging the wire harness thereon, wherein the first surface of the loading plate is provided with a ridge, and wherein the ridge is configured to restrict a movement of the wire harness when the harness fastening member fastens the wire harness to the first surface of the loading plate so as to push the wire harness against the first surface of the loading plate and the ridge.

(2) The wire harness clamp according to (1), wherein the ridge includes a transverse ridge extending in a direction perpendicular to an axial line of the wire harness, the transverse ridge arranged at a middle portion of the first surface of the loading plate in a direction along the axial line of the wire harness, and wherein the harness fastening member includes a first fastening member and a second fastening member which are separated from each other and arranged at both ends of the first surface of the loading plate in the direction along the axial line of the wire harness.

(3) The wire harness clamp according to (1), wherein the ridge includes a first transverse ridge and a second transverse ridge extending in a direction perpendicular to an axial line of the wire harness, the first transverse ridge and the second transverse ridge arranged at both ends of the first surface of the loading plate in a direction along the axial line of the wire harness, and wherein the harness fastening member is arranged between the first transverse ridge and the second transverse ridge.

(4) The wire harness clamp according to (1), wherein the ridge includes a transverse ridge extending in a direction perpendicular to an axial line of the wire harness and a longitudinal ridge extending along the axial line of the wire harness, and wherein the longitudinal ridge is inserted between wires constituting the wire harness when the harness fastening member fastens the wire harness to the first surface of the loading plate so as to push the wire harness against the first surface of the loading plate, the transverse ridge and the longitudinal ridge.

(5) The wire harness clamp according to (1), wherein the ridge deforms the wire harness to restrict a movement of the wire harness in a direction along an axial line of the wire harness and a rotation of the wire harness around the axial line of the wire harness when the harness fastening member fastens the wire harness to the first surface of the loading plate so as to push the wire harness against the first surface of the loading plate and the ridge.

By the configuration of (1), when the wire harness loaded on the first surface of the loading plate is fastened to the loading plate by the harness fastening member, the ridge provided on the first surface of the loading plate engages with the wire harness. The engagement of the ridge with the wire harness restricts the movement of the wire harness. In particular, the movement of the wire harness in the axial direction thereof and the rotation of the wire harness around the axis thereof are restricted. Thus, the wire harness is securely fixed to the loading plate.

In the configuration of restricting the movement of the wire harness with the engagement of the ridge with the wire harness, as compared to a configuration of restricting the movement of the wire harness with the tape winding, it is possible to stably restrict the position of the wire harness even though a length of the loading plate in the direction along the axial line of the wire harness is reduced. Accordingly, it is also possible to achieve the small size and light weight by reducing the length of the loading plate.

By the configuration of (2), the bent shape of a portion of the wire harness, which comes in contact with the ridge is opposite to the bent shape of a portion of the wire harness, which is fastened by the harness fastening member. Consequently, the wire harness is fixed to the loading plate in a zigzag shape. Thus, it is possible to increase the effect of restricting the movement of the wire harness in the axial direction thereof and the rotation of the wire harness around the axis thereof, thereby improving accuracy of positioning the wire harness.

Also in the configuration of (3), the bent shape of a portion of the wire harness, which comes in contact with the ridges is opposite to the bent shape of a portion of the wire harness, which is fastened by the harness fastening member. Consequently, the wire harness is fixed to the loading plate in a zigzag shape. Thus, it is possible to increase the effect of restricting the movement of the wire harness in the axial direction thereof or the rotation of the wire harness around the axis thereof, thereby improving accuracy of positioning the wire harness.

Further, in the configuration of (3), only one harness fastening member is arranged on the loading plate. Accordingly, it is possible to further facilitate an operation of fastening the wire harness by the harness fastening member and further improve the workability in attaching the wire harness.

By the configuration of (4), the transverse ridge deforms the wire harness to form the bent portion in the wire harness in the direction perpendicular to the axial line thereof, thereby preventing the wire harness from moving in the axial direction thereof with tension exerted on the wire harness. Meanwhile, the longitudinal ridge is inserted between the wires constituting the wire harness along the axial direction of the wire harness, thereby preventing the wire harness from rotating around the axis thereof with torsion exerted on the wire harness.

That is, the wire harness clamp surely restricts the movement of the wire harness in the axial direction thereof and the rotation of the wire harness around the axis thereof by the respective ridges. Accordingly, it is possible to more surely prevent the wire harness from moving in the axial direction thereof and rotating around the axis thereof.

In the wire harness clamp according to the invention, when the wire harness loaded on the first surface of the loading plate is fastened to the loading plate by the harness fastening member, the ridge provided on the first surface of the loading plate engages with the wire harness. The engagement of the ridge with the wire harness restricts the movement of the wire harness in the axial direction thereof and the rotation of the wire harness around the axis thereof, thereby securely fixing the wire harness to the loading plate.

Further, in the configuration of restricting the movement of the wire harness by the engagement of the ridge with the wire harness, as compared to a related art configuration of restricting the movement of the wire harness by the tape winding, it is possible to stably restrict the position of the wire harness even though a length of the loading plate in the axial direction of the wire harness is reduced. Accordingly, it is also possible to achieve the small size and light weight by reducing the length of the loading plate.

### BRIEF DESCRIPTION OF THE DRAWINGS

In the accompanying drawings:

FIG. 1 illustrates a side view of a wire harness clamp according to a first embodiment of the invention;

FIG. 2 illustrates a top plan view of the wire harness clamp illustrated in FIG. 1;

FIG. 3 illustrates a perspective view of a wire harness clamp according to a second embodiment of the invention;

FIG. 4 illustrates a perspective view of a wire harness clamp according to a third embodiment of the invention;

FIG. 5 illustrates an exploded perspective view of the wire harness clamp illustrated in FIG. 4;

FIG. 6 illustrates an enlarged perspective view of a loading plate and a panel connection portion of the wire harness clamp illustrated in FIG. 5, when seen from below;

FIG. 7 illustrates an enlarged perspective view of the loading plate of the wire harness clamp illustrated in FIG. 6, when seen from above; and

FIG. 8 illustrates a wire harness clamp according to the related art.

### DETAILED DESCRIPTION OF THE EMBODIMENTS

Hereinafter, a wire harness clamp according to embodiments of the invention will be described in detail with reference to the accompanying drawings.

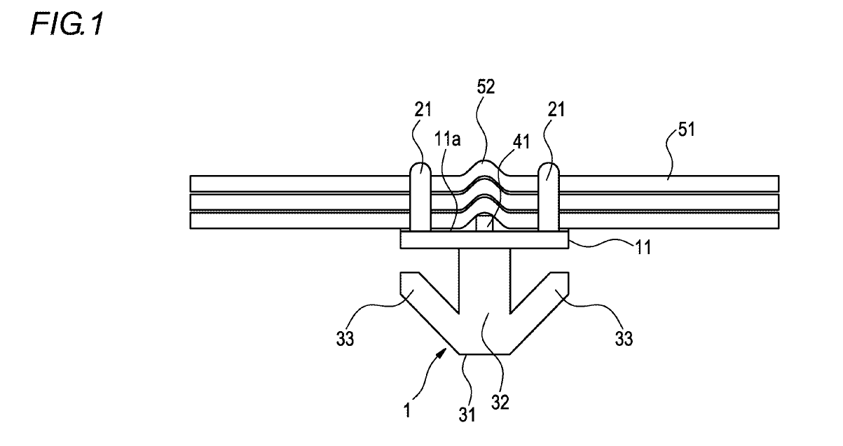

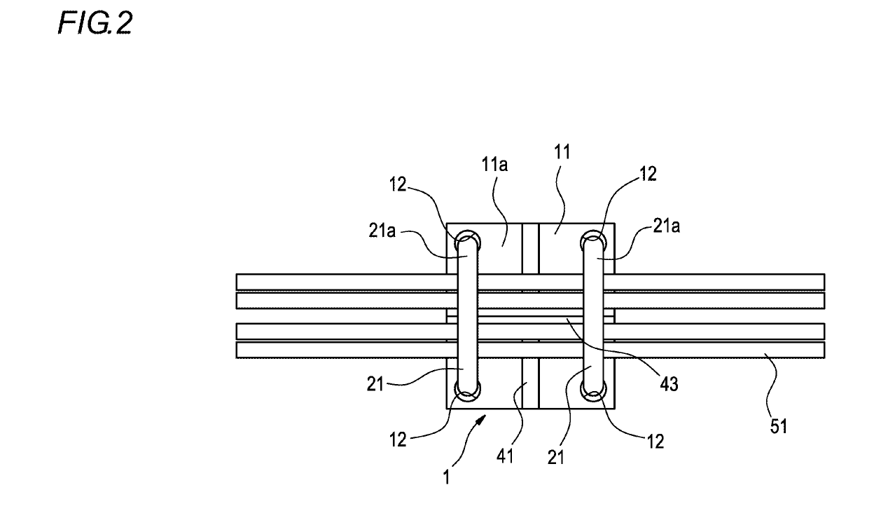

FIGS. 1 and 2 illustrate a wire harness clamp according to a first embodiment of the invention. FIG. 1 illustrates a side view of the wire harness clamp according to the first embodiment of the invention. FIG. 2 shows a plan view of the wire harness clamp illustrated in FIG. 1.

A wire harness clamp 1 according to the first embodiment includes a loading plate 11, harness fastening members 21, and a panel connection portion 31, and a ridge 41.

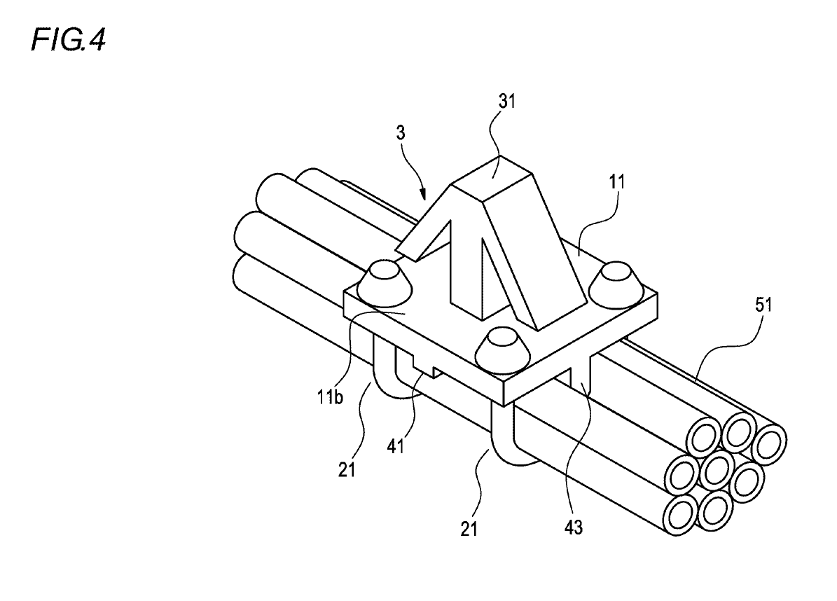

The loading plate 11 has a substantially flat plate shape and has an upper surface (a first surface) 11a and a lower surface (a second surface) 11b (see FIGS. 4 to 6) opposite to the upper surface. The upper surface 11a is configured to load a wire harness 51 thereon. In this embodiment, as shown in FIG. 2, the loading plate 11 is fowled into a rectangular shape having a horizontal dimension substantially equal to a vertical dimension.

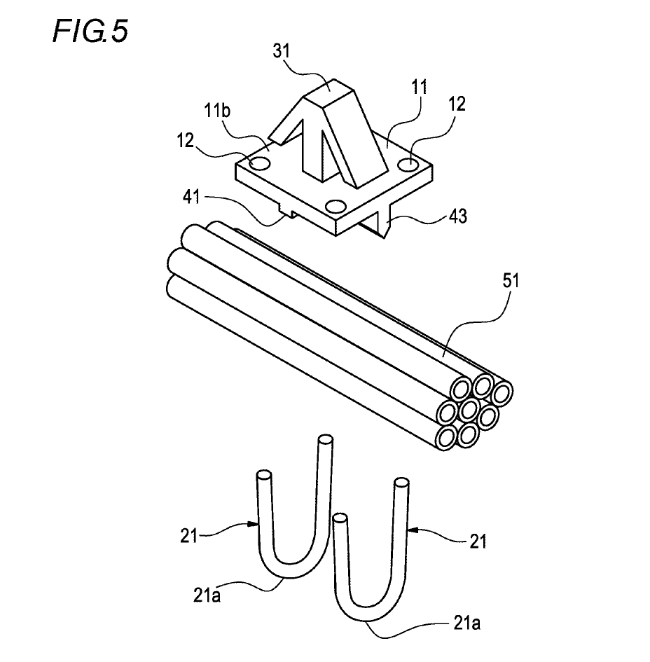

The harness fastening members 21 are configured to fasten the wire harness 51 to the upper surface 11 a of the loading plate 11. In this embodiment, the harness fastening members 21 are formed of a resin wire material 21a (see FIG. 5) having flexibility and are formed separately from the loading plate 11. The loading plate 11 is formed with wire insertion through holes 12. The harness fastening members 21 are fixed to the loading plate 11 by thermally bonding both ends of each resin wire material 21 a passing through the wire insertion through holes 12.

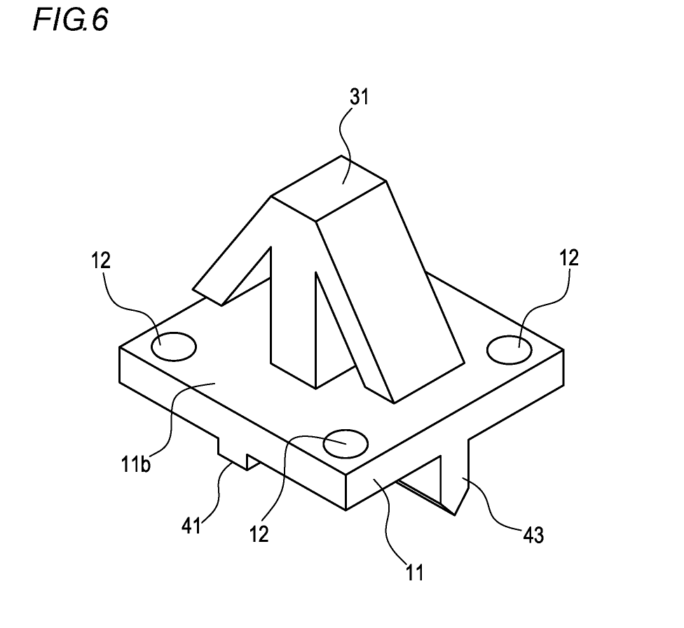

The wire insertion through holes 12 are configured to insert an end of the resin wire material 21 a therethrough. As illustrated in FIG. 6, four wire insertion through holes 12 in total are formed such that two holes are formed at the front side of the loading plate 11 and two holes are formed at the rear side of the loading plate 11. The panel connection portion 31 is formed on the lower surface of the loading plate 11.

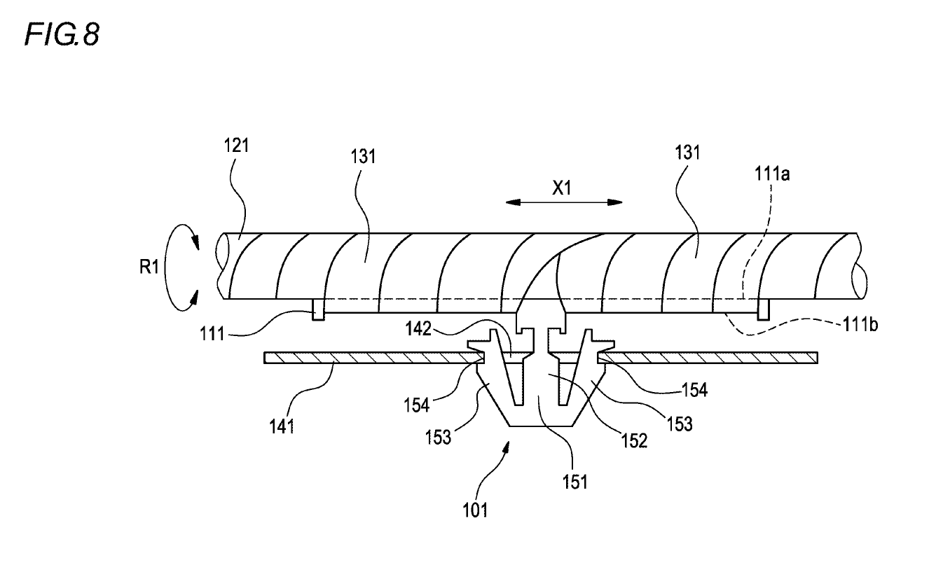

The panel connection portion 31 protrudes from a substantially central portion of the lower surface of the loading plate 11. The panel connection portion 31 is configured to be fitted in and fixed to a clamp attachment hole which is formed in a structure (not shown) (corresponding to the structure 141 of FIG. 8) for arranging the wire harness 51 thereon.

The panel connection portion 31 according to this embodiment includes a central shaft 32 configured to pass through the center of the clamp attachment hole (not shown), and spring pieces 33 extending obliquely from a leading end of the central shaft 32 toward a base end of the central shaft 32. After the spring pieces 33 are inserted into and passes through the clamp attachment hole while the spring pieces 33 are bent toward the central shaft 32, the spring pieces 33 are restored to their original shape at the under side of the clamp attachment hole and are engaged with a peripheral portion of the clamp attachment hole, thereby fixing the panel connection portion 31 to the structure.

The ridge 41 is provided on the upper surface 11a of the loading plate 11. In this embodiment, the ridge 41 is the transverse ridge 41 which extends in a direction perpendicular to an axial line of the wire harness 51. Furthermore, the transverse ridge 41 is arranged at a middle portion of the upper surface 11 a of the loading plate 11 in a direction along the axial line of the wire harness 51 (in a longitudinal direction of the axial line of the wire harness 51).

Moreover, in this embodiment, two harness fastening members 21 separated from each other are arranged at both ends of the upper surface 11 a of the loading plate 11 in the direction along eth axial line of the wire harness 51. The transverse ridge 41 is interposed between the harness fastening members 21.

As illustrated in FIG. 1, when the harness fastening members 21 fastens the wire harness 51 to upper surface 11a of the loading plate 11 and the wire harness 51 is pushed against the upper surface 11a of the loading plate 11 and the transverse ridge 41, the transverse ridge 41 engages with the wire harness 51 to form a bent portion 52 having a ridge shape extending in the direction perpendicular to the axial line of the wire harness 51. Thus, the transverse ridge 41 restricts the movement of the wire harness 51. In particular, the transverse ridge 41 is configured to restrict the movement of the wire harness 51 in the direction along the axial line thereof and the rotation of the wire harness 51 around the axial line thereof.

In the above-described wire harness clamp 1 according to the first embodiment, when the wire harness 51 loaded on the upper surface 11 a of the loading plate 11 is fastened to the loading plate 11 by the harness fastening members 21, the transverse ridge 41 provided on the upper surface 11 a of the loading plate 11 engages with the wire harness 51. This engagement of the transverse ridge 41 with the wire harness 51 forms in the wire harness 51 the bent portion 52 having a ridge shape extending in a direction perpendicular to the axial direction to restrict the movement of the wire harness 51 in the axial line thereof and the rotation of the wire harness 51 around the axial line thereof are restricted. Accordingly, the wire harness 51 is securely fixed to the loading plate 11.

Furthermore, in the configuration of restricting the movement of the wire harness 51 by the engagement of the transverse ridge 41, as compared to a related art configuration of restricting the movement of the wire harness by tape winding, it is possible to stably restrict the position of the wire harness 51 even though a length of the loading plate 11 in the direction along the axial line of the wire harness 51 is reduced. Accordingly, it is also possible to achieve the small size and light weight by reducing the length of the loading plate 11.

Moreover, in the wire harness clamp 1 according to the first embodiment, a bent shape of a portion of the wire harness 51, which comes in contact with the transverse ridge 41 is opposite to a bent shape of a portion of the wire harness 51, which is fastened by the harness fastening members 21. Consequently, the wire harness 51 is fixed to the loading plate 11 in a zigzag shape. Thus, it is possible to increase the effect of restricting the movement of the wire harness 51 in the direction along the axial line thereof and the rotation of the wire harness 51 around the axial line thereof, thereby improving accuracy of positioning the wire harness 51.

Moreover, in the wire harness clamp 1 according to the first embodiment, an operation of coupling the harness fastening members 21 with the loading plate 11 can be completed by performing a few processes, i.e., a wire moving process of inserting both ends of the resin wire material 21 a as the harness fastening members 21 into the wire insertion through holes 12 of the loading plate 11, and a thermally bonding process of thermally bonding both ends of the resin wire material 21a passing through the wire insertion through holes 12 of the loading plate 11. It is easy to achieve automation of this coupling operation, as compared to a tape winding operation according to the related art.

Accordingly, it is possible to improve workability of attachment of the wire harness 51 by automation (mechanization) of an attachment operation of the wire harness 51.

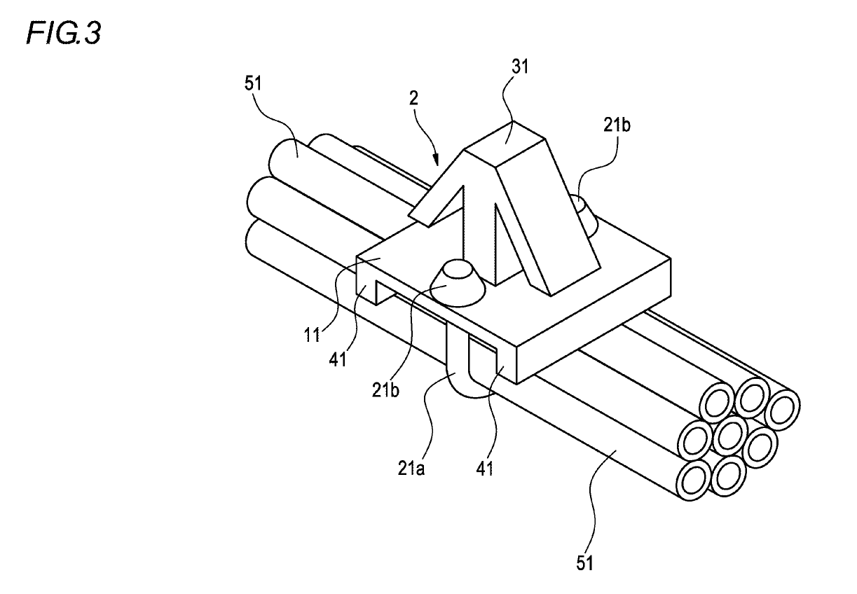

FIG. 3 illustrates a perspective view of a wire harness clamp according to a second embodiment of the invention. A wire harness clamp 2 of the second embodiment is a modification of a part of the wire harness clamp 1 of the first embodiment.

The wire harness clamp 2 according to the second embodiment has substantially the same configuration as the wire harness clamp 1 according to the first embodiment in that the panel connection portion 31 is formed on a middle portion of the lower surface of the loading plate 11 having a substantially square shape, the transverse ridge 41 is formed on the first surface of the loading plate 11, and the harness fastening member 21 for fastening the wire harness 51 to the loading plate 11 is formed of a resin wire material 21a separately from the loading plate 11.

In FIG. 3, reference numeral 21b denotes ends of the resin wire material 21a formed into a shape protruding in a radial direction due to a thermally bonding process.

Then, the differences between the wire harness clamp 2 according to the second embodiment and the wire harness clamp 1 according to the first embodiment will be described.

In the wire harness clamp 2 according to the second embodiment, two transverse ridges 41 each extending in the direction perpendicular to the axial line of the wire harness 51 are arranged at both ends of the upper surface of the loading plate 11 in the direction along the axial line of the wire harness 51 for restricting the movement of the wire harness 51.

The harness fastening member 21 is arranged at only one place on the upper surface of the loading plate 11 between the transverse ridges 41 to fasten the wire harness 51 to the loading plate 11 between the transverse ridges 41 provided at two places on the upper surface of the loading plate 11.

In the wire harness clamp 2 according to the second embodiment illustrated in FIG. 3, a bent shape of a portion of the wire harness 51, which comes in contact with the transverse ridges 41 is opposite to a bent shape of a portion of the wire harness 51, which is fastened by the harness fastening member 21. Consequently, the wire harness 51 is fixed to the loading plate 11 in a zigzag shape. Thus, it is possible to increase the effect of restricting the movement of the wire harness 51 in the direction along the axial line thereof and the rotation of the wire harness 51 around the axial line thereof, thereby improving accuracy of positioning the wire harness 51.

Moreover, in the wire harness clamp 2 according to the second embodiment, only one harness fastening member 21 is arranged on the loading plate 11, whereas two harness fastening members 21 are arranged on the loading plate 11 in the first embodiment. Accordingly, it is possible to further facilitate an operation of fastening the wire harness 51 with the harness fastening member 21 and further improve workability of the attachment of the wire harness 51.

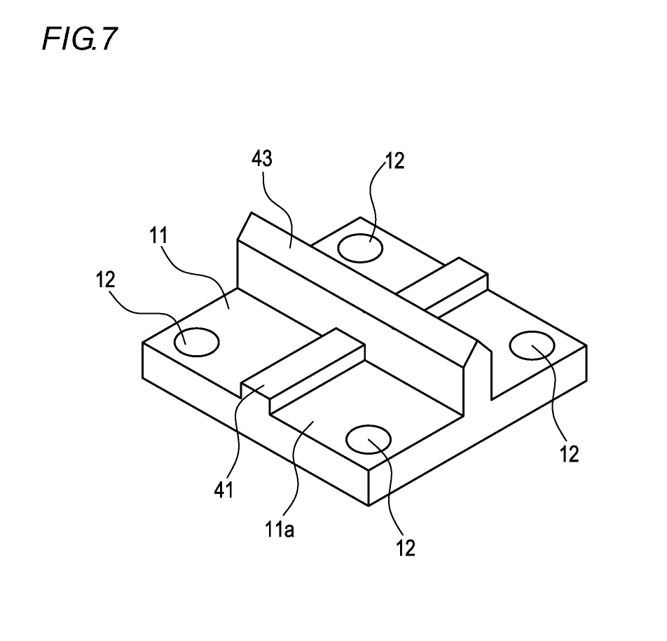

FIGS. 4 to 7 illustrate a wire harness clamp according to a third embodiment of the invention. FIG. 4 is a perspective view of the wire harness clamp according to the third embodiment of the invention. FIG. 5 is an exploded perspective view of the wire harness clamp illustrated in FIG. 4. FIG. 6 is an enlarged perspective view of a loading plate and a panel connection portion of the wire harness clamp illustrated in FIG. 5, when seen from below. FIG. 7 is an enlarged perspective view of the loading plate of the wire harness clamp illustrated in FIG. 6, when seen from above.

A wire harness clamp 3 of the third embodiment is a modification of a part of the wire harness clamp 1 of the first embodiment.

The wire harness clamp 3 according to the third embodiment includes a longitudinal ridge 43 which extends in the direction along axial line of the wire harness 51 in addition to the transverse ridge 41 explained in the first embodiment. The longitudinal ridge 43 is inserted between wires constituting the wire harness 51 when the wire harness 51 is fastened to the loading plate 11 and pushed against the upper surface of the loading plate 11.

The wire harness clamp 3 according to the third embodiment may have substantially the same configuration as the wire harness clamp 1 according to the first embodiment except for the longitudinal ridge 43. As for the same configuration, a description thereof will be omitted by assigning the same reference numerals.

In this embodiment, a leading end of the longitudinal ridge 43 is chamfered at an acute angle such that the longitudinal ridge 43 can be easily inserted between the wires of the wire harness 51.

In the above-described wire harness clamp 3 according to the third embodiment, the transverse ridge 41 deforms the wire harness 51 to form the bent portion in the wire harness 51 in the direction perpendicular to the axial line thereof, thereby preventing the wire harness 51 from moving in the direction along the axial line thereof with tension exerted on the wire harness 51. Meanwhile, the longitudinal ridge 43 is inserted between the wires constituting the wire harness 51 along the axial direction of the wire harness 51, thereby preventing the wire harness 51 from rotating around the axial line of the wire harness 51 with torsion exerted on the wire harness 51.

That is, the wire harness clamp 3 according to the third embodiment surely restricts the movement of the wire harness 51 in the direction along the axial line thereof and the rotation of the wire harness 51 around the axial line thereof by the respective ridges. Accordingly, it is possible to more surely prevent the wire harness 51 from moving in the axial direction and rotating around the axis.

The invention is not limited to the above-described embodiments, and appropriate modification and improvement and the like can be made. Further, in the above-described embodiments, no limitation is imposed on the material, shape, dimension, value, form, number, installation position and the like of each of the components if the invention can be achieved.

1. A wire harness clamp, comprising:
a loading plate having a first surface configured to load a wire harness thereon and a second surface opposite to the first surface;
a harness fastening member configured to fasten the wire harness to the first surface of the loading plate; and
a connection portion formed on the second surface of the loading plate and configured to be fitted in and fixed to a clamp attachment hole which is formed in a structure for arranging the wire harness thereon,
wherein the first surface of the loading plate is provided with a ridge, and
wherein the ridge is configured to restrict a movement of the wire harness when the harness fastening member fastens the wire harness to the first surface of the loading plate so as to push the wire harness against the first surface of the loading plate and the ridge.

2. The wire harness clamp according to claim 1,
wherein the ridge includes a transverse ridge extending in a direction perpendicular to an axial line of the wire harness, the transverse ridge arranged at a middle portion of the first surface of the loading plate in a direction along the axial line of the wire harness, and
wherein the harness fastening member includes a first fastening member and a second fastening member which are separated from each other and arranged at both ends of the first surface of the loading plate in the direction along the axial line of the wire harness.

3. The wire harness clamp according to claim 1,
wherein the ridge includes a first transverse ridge and a second transverse ridge extending in a direction perpendicular to an axial line of the wire harness, the first transverse ridge and the second transverse ridge arranged at both ends of the first surface of the loading plate in a direction along the axial line of the wire harness, and
wherein the harness fastening member is arranged between the first transverse ridge and the second transverse ridge.

4. The wire harness clamp according to claim 1,
wherein the ridge includes a transverse ridge extending in a direction perpendicular to an axial line of the wire harness and a longitudinal ridge extending along the axial line of the wire harness, and
wherein the longitudinal ridge is inserted between wires constituting the wire harness when the harness fastening member fastens the wire harness to the first surface of the loading plate so as to push the wire harness against the first surface of the loading plate, the transverse ridge and the longitudinal ridge.

5. The wire harness clamp according to claim 1, wherein the ridge deforms the wire harness to restrict a movement of the wire harness in a direction along an axial line of the wire harness and a rotation of the wire harness around the axial line of the wire harness when the harness fastening member fastens the wire harness to the first surface of the loading plate so as to push the wire harness against the first surface of the loading plate and the ridge.
